(19) United States
(12) Patent Application Publication
(10) Pub. No.: US 2011/0017719 A1
(43) Pub. Date: Jan. 27, 2011

(54) HEATER AND MANUFACTURING METHOD FOR SAME

(76) Inventors: Hyeon Choi, Daejeon Metropolitan City (KR); Dong-Wook Lee, Daejeon Metropolitan City (KR); In-Seok Hwang, Daejeon Metropolitan City (KR); Sang-Ki Chun, Daejeon Metropolitan City (KR); Su-Jin Kim, Daejeon Metropolitan City (KR); Ki-Hwan Kim, Daejeon Metropolitan City (KR); Young-Jun Hong, Daejeon Metropolitan City (KR)

Correspondence Address: MCKENNA LONG & ALDRIDGE LLP, 1900 K STREET, NW, WASHINGTON, DC, 20006, US

(21) Appl. No.: 12/933,077

(22) PCT Filed: Mar. 17, 2009
(86) PCT No.: PCT/KR2009/001339

§ 371 Date: Sep. 16, 2010

(30) Foreign Application Priority Data
Mar. 17, 2008 (KR) 10-2008-0024458
Mar. 17, 2008 (KR) 10-2008-0024460
Mar. 17, 2008 (KR) 10-2008-00224461
Mar. 21, 2008 (KR) 10-2008-0026545
Mar. 21, 2008 (KR) 10-2008-0026546
Mar. 21, 2008 (KR) 10-2008-0026547
Mar. 21, 2008 (KR) 10-2008-0026548
Mar. 21, 2008 (KR) 10-2008-0026550
May 15, 2008 (KR) 10-2008-0045176
May 15, 2008 (KR) 10-2008-0045177
May 15, 2008 (KR) 10-2008-0045178
May 15, 2008 (KR) 10-2008-0045179

(51) Int. Cl. F23Q 7/00; H05B 3/00

(52) U.S. Cl. 219/260; 29/611

(57) ABSTRACT

Provided are a method for manufacturing a heating element, which includes: determining a form of a pattern in which a line width is 100 micrometers or less and an opening ratio is in the range of 70% to 99%; printing a paste that includes the conductive heating material according to the determined pattern on at least one side of a resin film; forming a conductive heating pattern by sintering the printed paste that includes the conductive heating material; forming bus bars on both sides of the conductive heating pattern; attaching a transparent substance to at least one side of the resin film that has the conductive heating pattern; and providing a power portion that is connected to the bus bar, and a heating element that is manufactured by using the method.

### TECHNICAL FIELD

The present invention relates to a heating element and a method for manufacturing the same. More particularly, the present invention relates to a heating element that is not well visible, has excellent heating performance at a low voltage, and a method for manufacturing the same.

### BACKGROUND ART

In winter or rainy day, frost is formed on a glass surface of a vehicle because of a difference between temperatures of the outside and inside of the vehicle. In addition, in the case of an indoor ski resort, a freezing phenomenon occurs because of a difference between temperatures of the inside where there is a slope and the outside of the slope. In order to solve this, a heating has been developed. The heating glass uses a concept where after a hot line sheet is attached to the glass surface or a hot line is directly formed on the glass surface, a current is applied to both terminals of the hot line to generate heat from the hot line, thereby increasing the temperature of the glass surface. It is important that the heating glass for vehicle or construction has low resistance in order to smoothly generate heat, but it should not be offensive to human eye. Accordingly, methods for manufacturing a known transparent heating glass by forming a heating layer through a sputtering process using a transparent conductive material such as ITO (Indium Tin Oxide) or Ag thin film and connecting an electrode to a front end thereof have been proposed. However, the heating glass according to the above method has a problem in that it is difficult to drive it at a low voltage of 40 V or less because of high surface resistance. As the other method, in a photolithography method, since a manufacturing process is complicated and material waste is severe, it is impossible to manufacture products at low cost, such that it cannot be used to manufacture the heating glass.

### DISCLOSURE

### Technical Problem

In order to solve the above problems, the present invention has been made in an effort to provide a heating element that is not well visible and has excellent heating performance at a low voltage, and a method for easily manufacturing the same at low cost.

### Technical Solution

In order to accomplish the above object, an exemplary embodiment of the present invention provides a method for manufacturing a heating element, which includes: determining a form of a pattern in which a line width is 100 micrometers or less and an opening ratio is in the range of 70% to 99%; printing a paste that includes the conductive heating material according to the determined pattern on at least one side of a resin film; forming a conductive heating pattern by sintering the printed paste that includes the conductive heating material; forming bus bars on both sides of the conductive heating pattern; attaching a transparent substance to at least one side of the resin film that has the conductive heating pattern; and providing a power portion that is connected to the bus bar.

In addition, another exemplary embodiment of the present invention provides a heating element that includes: a) a resin film; b) a conductive heating pattern that is disposed on at least one side of the resin film, a line width of the pattern being 100 micrometers or less, an opening ratio of the pattern being 70% to 99%; c) a bus bar that is disposed on both ends of the conductive heating pattern; d) a power portion that is connected to the bus bar; and e) a transparent substance that is provided on at least one side of the resin film on which the conductive heating pattern is formed.

It is preferable that the conductive heating pattern of the heating element is formed by using an offset printing method, gravure printing method, flaxo printing method, inkjet printing method, or one or more complex methods of the printing methods.

### ADVANTAGEOUS EFFECTS

According to the exemplary embodiments of the present invention, the method for manufacturing a heating element may provide a heating element that has a conductive heating pattern that is not well visible because of a thin line width, has low resistance, and has excellent heating performance at a low voltage, and the process is easily performed and its cost is low.

### DESCRIPTION OF DRAWINGS

FIG. 1 is a view that illustrates an offset printing process.

FIG. 2 illustrates an example of a heating element for vehicles according to an exemplary embodiment of the present invention.

FIG. 3 is a picture of the heating element according to an exemplary embodiment of the present invention.

FIGS. 4 to 8 illustrate the form of the conductive heating pattern of the heating element according to the present invention.

FIGS. 9 to 14 illustrate the conductive heating pattern according to an exemplary embodiment of the present invention.

### BEST MODE

Hereinafter, the present invention will be described in detail.

A method for manufacturing a heating element according to an exemplary embodiment of the present invention includes: determining a form of a pattern in which a line width is 100 micrometers or less and an opening ratio is in the range of 70% to 99%; printing a paste that includes the conductive heating material according to the determined pattern on at least one side of a resin film; forming a conductive heating pattern by sintering the printed paste that includes the conductive heating material; forming bus bars on both sides of the conductive heating pattern; attaching a transparent substance to at least one side of the resin film that has the conductive heating pattern; and providing a power portion that is connected to the bus bar. In the present invention, the opening ratio of the pattern is more preferably 70% to 97.5% and more preferably 80% to 97.5%.

In the case of when the transparent conductive thin film layer such as ITO is used like the related art, there is a problem in that surface resistance. Since the photolithography method is complicated and high cost is required, it cannot be used in the manufacturing of the heating element. In addition, in the related art, the heating pattern is formed by attaching the metal line to the glass or attaching the metal paste to the glass by using the method such as screen printing, but in the case of when this method is used, since the line of the heating pattern is too thick, it is apparently observed by the naked eye. Accordingly, it may not be applied to the purpose of the front window for the vehicle where it is important that a view field is ensured.

However, in the present invention, when the heating element is manufactured, the form of the conductive heating pattern is previously determined so that the line width of the pattern is 100 micrometers or less and the pattern the opening ratio is 70% to 99%, and the conductive heating pattern is formed by using the printing method. The heating element which has low surface resistance and excellent heating performance at a low voltage and in which since the heating pattern cannot be discriminated by the naked eye may be provided by making the interval between the lines narrow and controlling the opening ratio, that is, the area that is not occupied by the pattern, within a predetermined range while the conductive heating pattern has the thin line width.

In addition, the form of the finally formed conductive heating pattern may be predicted by previously determining the form of the pattern and forming the heating pattern as it stands on the resin film by using the printing method. Therefore, it is possible to predict the form of the heating pattern on the heating element or performance of the heating element and it is possible to easily manage them. Accordingly, as compared to the pattern that is randomly formed, the state and performance of the heating element are more advantageously managed.

In addition, by forming the form of the above pattern by using the printing method, a relatively low cost is required, the manufacturing process is simple, and it is possible to form the precise conductive heating pattern that has the thin line width.

In particular, in the present invention, it is possible to more simplify the manufacturing process of the heating element by the conductive heating pattern on the resin film, and various materials and various printing methods, for example, a roll printing process and the like may be used.

In the present invention, the printing method is not particularly limited, but an offset printing method, gravure printing method, flaxo printing method, inkjet printing method, or one or more complex methods of the printing methods may be used. The printing method may use a roll to roll method, roll to plate, plate to roll or plate to plate method.

In detail, the offset printing may be performed by using the method in which after the paste is filled in the intaglio on which the pattern is formed, first transferring is performed by using silicon rubber that is called as the blanket, and the second transferring is performed by closely contacting the blanket and the resin film. The gravure printing may be performed by using the method in which after the paste is filled in the pattern while the blanket where the pattern is formed on the roll is wound, it is transferred on the resin film. In the present invention, the above method may be used and the above methods may be used in combination. In addition, the other printing method that is known to those who are skilled in the art may be used.

In the case of the offset printing method, because of the release property of the blanket, since most of the paste is nearly transferred on the resin film, a separate blanket washing process is not required. The intaglio may be manufactured by precisely etching the glass on which the desired electric conductive heating pattern is formed, and metal or DLC (diamond-like carbon) coating may be performed on the glass surface for the durability. The intaglio may be manufactured by etching the metal plate.

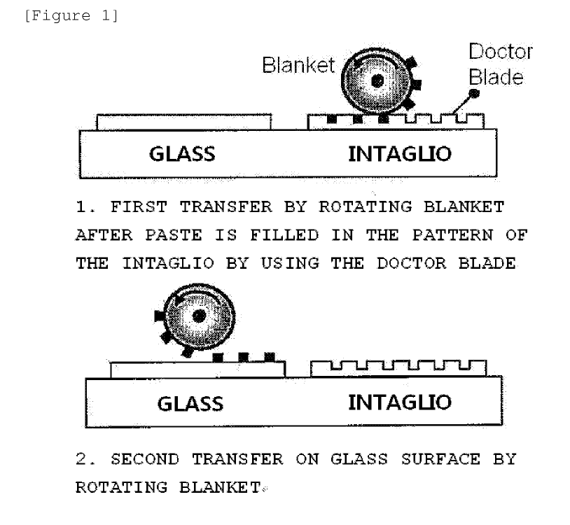

In the present invention, in order to implement the more precise conductive heating pattern, it is preferable to use the offset printing method. FIG. 1 illustrates the offset printing method. According to FIG. 1, after the paste is filled in the pattern of the intaglio by using the doctor blade as the first step, the first transferring is performed by rotating the blanket, and as the second step, the second transferring is performed on the resin film by rotating the blanket.

In the present invention, it is preferable that as the conductive heating material, metal that has an excellent thermal conductivity is used. In addition, the specific resistance value of the conductive heating pattern material is in the range of 1 microOhm cm to 200 microOhm cm. As a detailed example of the conductive heating pattern material, copper, silver, carbon nanotube (CNT) may be used, and silver is most preferable. In the present invention, the conductive heating material may be used in a particle form. In the present invention, as the conductive heating pattern material, copper particles that are coated with silver may be used.

In the present invention, the paste may further include an organic binder in addition to the above conductive heating material so that the printing process is easily performed. It is preferable that the organic binder has a volatile property in the sintering process. As the organic binder, there are polyacryl resin, polyurethane resin, polyester resin, polyolefine resin, polycarbonate resin and cellulose resin, polyimide resin, polyethylene naphthalate resin and denatured epoxy resin, but it is not limited thereto.

In order to improve the attachment ability of the paste to the resin film or transparent substance, the paste may further include a glass frit. The glass frit may be selected from commercial products, but it is preferable to use the environmentally friendly glass frit that includes no lead component. In this case, it is preferable that the average diameter of the glass frit is 2 micrometers or less and the maximum diameter thereof is 50 micrometers or less.

If necessary, a solvent may be further added to the paste. As the solvent, there are butyl carbitol acetate, carbitol acetate, cyclohexanon, cellosolve acetate and terpineol, but it is not limited thereto.

In the present invention, in the case of when the paste that includes the conductive heating pattern material, organic binder, glass frit and solvent is used, it is preferable that the weight ratio of the conductive heating material is 50 to 90%, the weight ratio of the organic binder is 1 to 20%, the weight ratio of the glass frit is 0.1 to 10% and the weight ratio of the solvent is 1 to 20%.

The above paste may be printed so that the line width of the line that forms the conductive heating pattern is 100 micrometers or less, preferably 70 micrometers or less, more preferably 50 micrometers or less, much more preferably 30 micrometers or less by using the printing method. In particular, in the case of when the line width is 30 micrometers or less, since the conductive heating pattern is not shown by the eye, it is advantageous to ensure the view field. For example, the line width of the conductive heating pattern may be in the range of 5 micrometers to 30 micrometers by the printing method.

In the present invention, the above heating pattern may be formed so that the line width and the line height are uniform by the method or it may artificially include the different line widths or line heights. That is, in the case of when the printing method is used by using the paste, it is possible to control the interval between lines of the conductive heating pattern. In the pattern, since it is preferable that the opening ratio, that is, the ratio of the area of the resin film that is not covered with the pattern is 70% or less, it is preferable that the interval between the lines of conductive heating pattern is 30 mm or less. In the case of when the conductive heating patterns do not cross each other, it is preferable that the interval between the lines of the conductive heating pattern is 200 micrometers or more and 30 mm or less. The height of the line from the resin film may be printed so that it is 1 to 100 micrometers, and preferably about 3 micrometers.

The line width and line height of the heating pattern may be made uniform by the above methods. In the present invention, the uniformity of the heating pattern may be in the range of ±3 micrometers in the case of the line width and in the range of ±1 micrometer in the case of the line height.

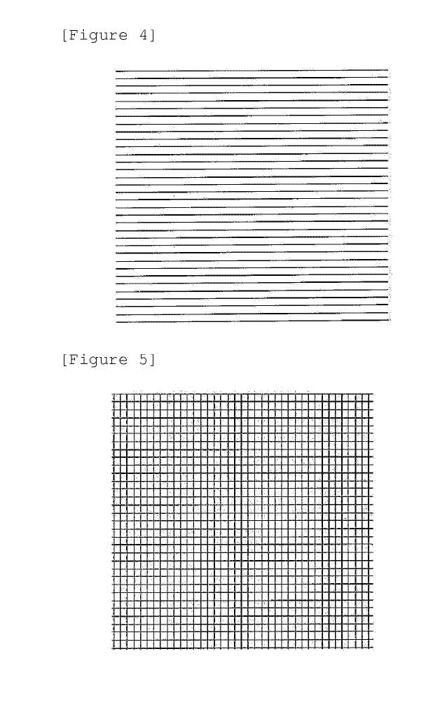

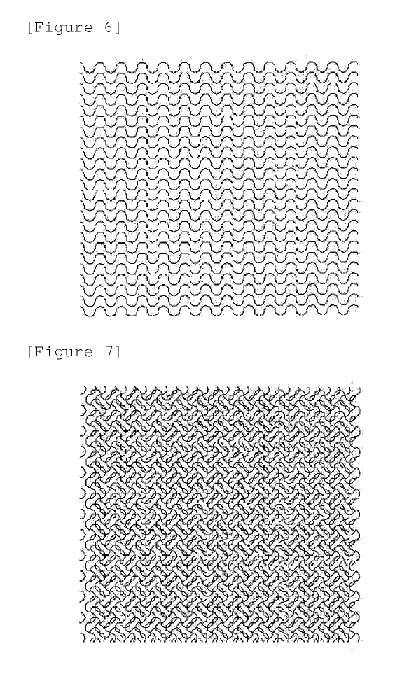

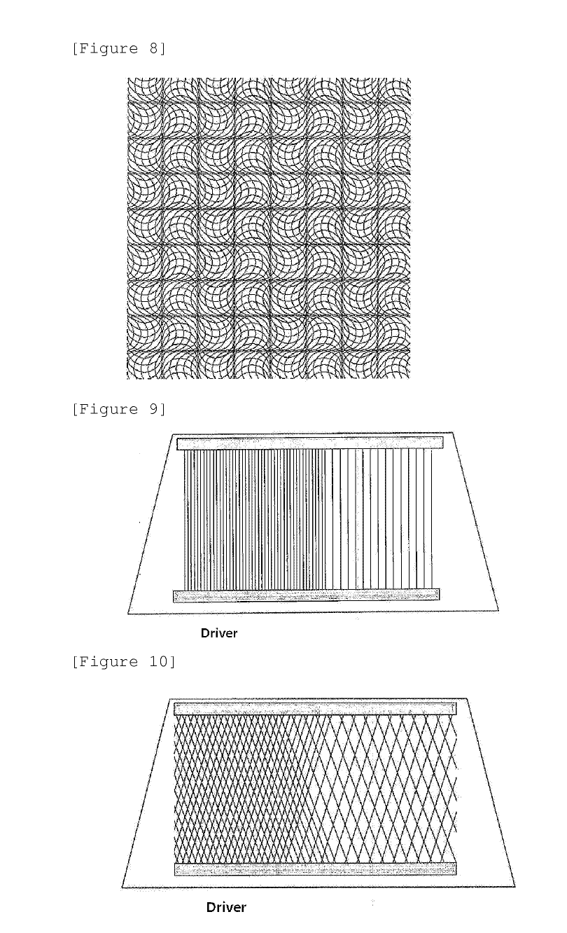

The printing pattern may be stripe, diamond, rectangular lattice, circle, wave pattern, grid, 2-dimensional grid, and the like as shown in FIGS. 3, 4 to 7, but is not limited to a predetermined form, and it is preferable that it is designed so that light that is emitted from a predetermined light source does not suppress optical properties by diffraction and interference. That is, in order to minimize the regularity of the pattern, the spacing of the tide pattern, sine wave, and the lattice structure and the pattern where the line thickness is made nonuniform may be used. In addition, in order to improve the optical properties, various patterns as shown in FIG. 8 may be added in addition to the above pattern. In addition, the additional dot patterns may be irregularly formed while they are not connected to the above pattern. In this case, it is preferable that the patterns and the dot patterns have the size of 30 micrometers or less. If necessary, the printing pattern may be a combination of two or more patterns. In the present invention, the line that configures the heating pattern may be formed of the straight lines, or various modifications such as curved lines, wave lines, and zigzag lines may be feasible.

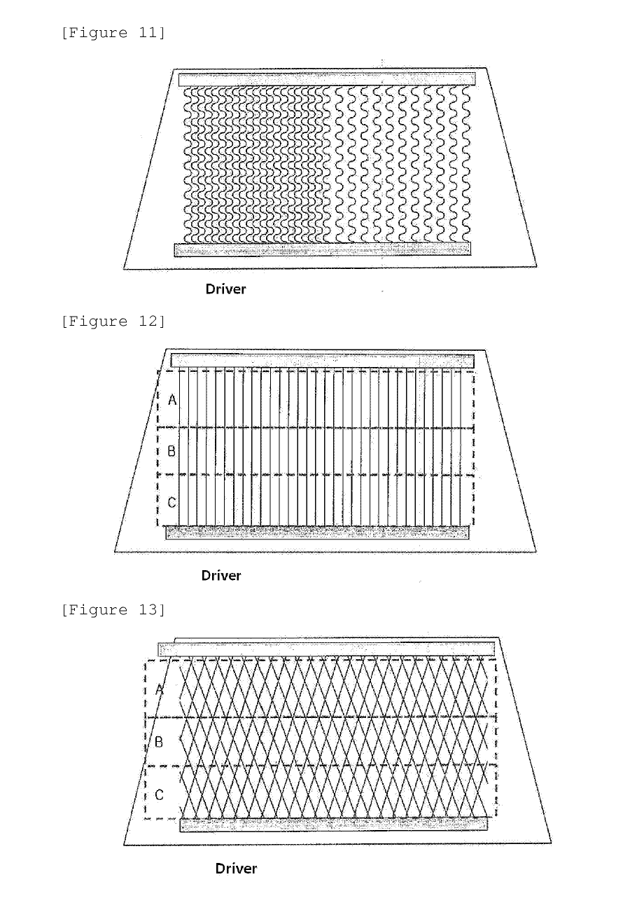

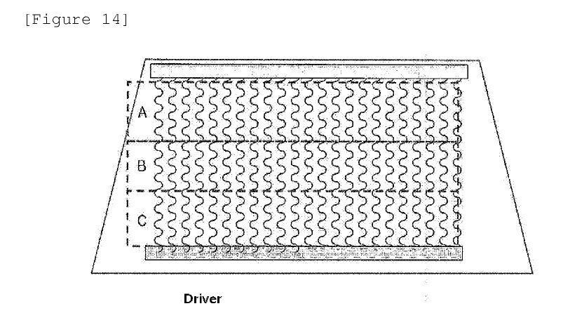

In the present invention, in the case of when the heating pattern is formed on the transparent substance by using the following method, the line width and line height may be made uniform. According to an exemplary embodiment of the present invention, at least a portion of the conductive heating pattern may be different from the remaining pattern. The desired heating pattern may be obtained by this configuration. For example, in the vehicle glass, in order to ensure the view field first in the area which corresponds to the front surface of the driver, the heating patterns of the corresponding area and the remaining area may be different from each other. The line widths and line intervals of the printing pattern may be different from each other so that at least a portion of the heating pattern is different from the remaining printing pattern. Therefore, the heating may more rapidly or efficiently occur at a desired place. That is, as shown in FIGS. 9 to 11, the interval between the lines may be controlled, and as shown in FIGS. 12 to 14, much heat emission may be obtained in the B area by using the large line width in the A and C areas and the small line width in the B area. The heating element according to an exemplary embodiment of the present invention may include at least two areas where the line widths or line intervals of the heating pattern are different.

According to an exemplary embodiment of the present invention, the heating element may include an area in which the conductive heating pattern is not formed. Transmission and reception that have a predetermined frequency can be performed by allowing at least a portion of the heating element not to form the conductive heating pattern, and information transmission and reception may be performed between the internal space and the external space. In this case, the area in which the conductive heating pattern is not formed may have an area that varies according to the desired frequency of the transmission and reception. For example, in order to pass the electromagnetic wave of 1.6 GHz that is used in the GPS, the area that has the long side that is ½ (9.4 cm) or more of the above wavelength is required. The area in which the conductive heating pattern is not formed may have an area that can transmit and receive the desired frequency, and its form is not particularly limited. For example, in the present invention, in order to pass the electromagnetic wave, the area in which the conductive heating pattern is not formed may the heating element that is provided with one or more semicircular areas that have the diameter of 5 to 20 cm.

According to an exemplary embodiment of the present invention, the conductive heating pattern may be blackened. If the paste that includes the metal material is sintered at the high temperature, metal gloss is shown, such that the visibility may be lowered because of the reflection of light. The problem may be prevented by blackening the conductive heating pattern. In order to blacken the conductive heating pattern, the blackening material may be added to the paste for forming the heating pattern or the blackening treatment may be performed after the paste is printed and sintered, thereby blackening the conductive heating pattern.

As the blackening material that may be added to the paste, there are metal oxide, carbon black, carbon nanotube, black pigment, colored glass frit and the like. In this case, the composition of the paste may include 50 to 90 wt % of the conductive heating material, 1 to 20 wt % of organic binder, 1 to 10 wt % of blackening material, 0.1 to 10 wt % of glass frit, and 1 to 20 wt % of solvent.

When the blackening treatment is performed after the sintering, the composition of the paste may include 50 to 90 wt % of the conductive heating material, 1 to 20 wt % of organic binder, 0.1 to 10 wt % of glass frit, and 1 to 20 wt % of solvent. The blackening treatment after the sintering includes dipping into the oxidized solution, for example, solution that includes the Fe or Cu ion, dipping into the solution that includes halogen ions such as a chlorine ion, dipping into hydrogen peroxide and nitric acids, and treatment using the halogen gas.

In the present invention, as the resin film, it is preferable to use the film that is formed of the polymer resin. As the polymer resin, one or more resins that are selected from a polyacryl-based resin, polyurethane-based resin, polyester-based resin, polyolefine-based resin, polycarbonate-based resin, cellulose-based resin, polyethylene naphthalate, PVB, and EVA may be used. Here, the board that has the film form may be rigid or flexible.

Since the resin film is the polymer film, the conductive paste is most preferably a low sintering type silver conductive paste. Here, the low temperature is 50 to 350° C., preferably 200° C. or less, and more preferably 150° C. or less. For example, in the case of when the resin film is PET (Polyethylene Terephthalate), it is preferable that it is 150° C. or less. The thickness of the resin film may be 12.5 to 500 micrometers and preferably 50 to 250 micrometers.

As described above, after the conductive heating pattern is formed through the sintering step, the step for forming the bus bar at both ends of the conductive heating pattern, the step for attaching the transparent substance to at least one side of the resin film that has the conductive heating pattern, and the step for providing the power portion that is connected to the bus bar are performed. These steps may use a method that is known in the art.

For example, the bus bar may be simultaneously formed in conjunction with the formation of the conductive heating pattern, and may be formed by using the other printing method after the conductive heating pattern is formed. For example, after the conductive heating pattern is formed by using the offset printing method, the bus bar may be formed through the screen printing. In this case, it is appropriate that the thickness of the bus bar is 1 to 100 micrometers and it is preferably 10 to 50 micrometers. If it is less than 1 micrometer, since the contact resistance between the conductive heating pattern and the bus bar is increased, local heating may be performed at the contact portion, and if it is less than 100 micrometers, the cost of the electrode material is increased. The connection between the bus bar and power may be performed through soldering and physical contact to the structure that has good conductive heat emission.

The step for attaching the transparent substance to at least one side of the resin film that has the conductive heating pattern may be performed, for example, by inserting the resin film on which the conductive heating pattern is printed between the transparent substance and using two attachment films. The transparent substance may be a glass or plastic substrate or a plastic film.

In order to conceal the conductive heating pattern and the bus bar, the black pattern may be formed. The black pattern may be printed by using the paste that includes cobalt oxides. In this case, it is appropriate the printing method is the screen printing, and its thickness is 10 to 100 micrometers. The conductive heating pattern and the bus bar may be formed before or after the black pattern is formed.

The heating element according to an exemplary embodiment of the present invention may include additional transparent substance on at least one side thereof. When the additional transparent substance is attached, the attachment film may be used. In the course of attaching them, the temperature and pressure may be controlled.

In one detailed embodiment, the attachment film is inserted between the heating element according to an exemplary embodiment of the present invention and additional transparent substance, and they are put into the vacuum bag, and reduced in pressure or increased in temperature or increased in temperature by using the hot roll, thus removing the air, thereby accomplishing first attachment. In this case, the pressure, temperature and time may vary according to the kind of the attachment film, and in general, the temperature may be gradually increased from normal temperature to 100° C. at a pressure of 300 to 700 Torr. In this case, it is preferable that the time is generally 1 hour or less. The preliminarily attached layered structure that is first attached is subjected to the second attachment process by the autoclave process where the temperature is increased while the pressure is added in the autoclave. The second attachment varies according to the kind of the attachment film, but it is preferable that after the attachment is performed at the pressure of 140 bar or more and the temperature in the range of 130 to 150° C. for 1 to 3 hours, it is slowly cooled.

In the other detailed embodiment, the method for attaching them through one step by using the vacuum laminator device unlike the above two step attachment process may be used. The attachment may be performed by stepwisely increasing the temperature to 80 to 150° C. and cooling them so that the pressure is lowered (˜5 mbar) until the temperature is 100° C. and thereafter the pressure is added (˜1000 mbar).

Here, any material that has an adhesive strength and is transparent after attaching may be used as the material of the adhesive film. For example, the PVB film, EVA film, PU film and the like may be used, but is not limited thereto. The adhesive film is not particularly limited, but it is preferable that its thickness is in the range of 100 micrometers to 800 micrometers.

In the above method, the additional attached transparent substance may be formed of only the transparent substance and may be formed of the transparent substance that is provided with the conductive heating pattern that is manufactured as described above. The additional transparent substance may be a glass or plastic substrate or a plastic film.

In addition, another exemplary embodiment of the present invention provides a heating element that includes: a) a resin film; b) a conductive heating pattern that is disposed on at least one side of the resin film, a line width of the pattern being 100 micrometers or less, an opening ratio of the pattern being 70% to 99%; c) a bus bar that is disposed on both ends of the conductive heating pattern; d) a power portion that is connected to the bus bar; and e) a transparent substance that is provided on at least one side of the resin film on which the conductive heating pattern is formed. It is preferable that the conductive heating pattern of the heating element is formed by the printing method. The heating element may include additional transparent substance on at least one side thereof. The transparent substance may be a glass or plastic substrate or a plastic film.

The conductive heating pattern that is formed by the printing method may slightly vary according to the kind of the paste or the printing method, but the surface thereof may be rounded by the surface tension. This surface shape may not be formed by a known photolithography method. The vertical cross section of the pattern that is rounded may be a lenticular lens. It is preferable that the angle between the tangent at the contact point between the pattern and the surface of resin film and the surface of the resin film is 80° or less, preferably 75° or less, and more preferably 60° or less. It is preferable that in the rounded upper surface of the vertical cross section of the pattern, the straight line area is 1/50 or less in a circumference direction.

The line width of the conductive heating pattern of the heating element 100 micrometers or less, preferably 50 micrometers or less, more preferably 30 micrometers or less, much more preferably 25 micrometers or less, and the interval between the lines is 30 mm or less, and the height of the line is 1 to 100 micrometers, and more preferably about 3 micrometers.

The heating element according to an exemplary embodiment of the present invention may to the power for heat emission, and In this case, the heating amount is 100 to 700 W per m², and preferably 200 to 300 W. Since the heating element according to an exemplary embodiment of the present invention has excellent heating performance at the low voltage, for example, 30 V or less, and preferably 20 V or less, it may be usefully used in vehicles and the like. The resistance of the heating element is 5 ohm/square or less, preferably 1 ohm/square or less, and more preferably 0.5 ohm/square or less.

The heating element according to an exemplary embodiment of the present invention may have a shape of curved surface.

In the heating element according to an exemplary embodiment of the present invention, it is preferable that the opening ratio of the conductive heating pattern, that is, the area ratio of the resin film that is not covered with the pattern is 70% or more. For the uniform heating and visibility of the heating element, it is preferable that the opening ratio of the pattern is constant in the unit area. It is preferable that the permeability deviation of the heating element is 5% or less in respects to a predetermined circle that has the diameter of 20 cm. In this case, the heating element may prevent the local heat emission. In addition, in the heating element, after the heat emission, the standard deviation of the surface temperature of the transparent substance is within 20%, and preferably after the heat emission, within 10% for 5 min.

Since the heating element according to an exemplary embodiment of the present invention has the conductive heating pattern that is formed by using, five or more pattern lines may be disposed per 1 cm of the length of the bus bar.

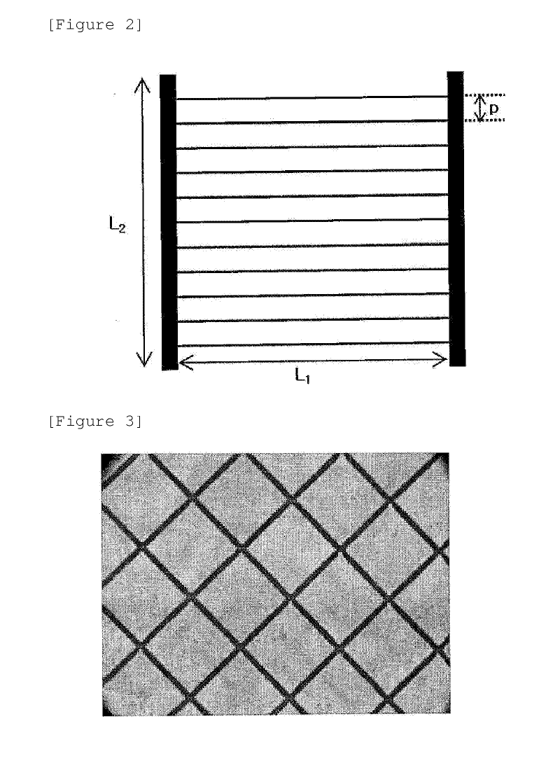

FIG. 2 illustrates the detailed embodiment of the heating element for vehicles. It is assumed that the heating amount is 200 to 300 W, in the case of when the hot line where the line width is 20 micrometers and the height is 1.5 micrometers is formed in conjunction with the drawings, if three hot lines per 1 mm, that is, the hot line where the pitch is about 330 micrometers is formed, a desired performance is implemented. In this case, the permeability is 310/330=93.9%, which is sufficient to be used for vehicles. In addition, in the case of when specific resistance of the hot line material is two times higher, if the pitch is 165 micrometers, since the permeability is 87.8% while the same heating amount is obtained, this is the permeability that is enough to be used for vehicles.

The heating element that has the stripe shape according to FIG. 2 has the following physical properties.

R(Ω)=ρ*(L₁/nA)=ρ*(L₁*p)/(L₂*w*h)

Ar(%)=(1−w/p)*100

R: resistance between bus bars

Ar: opening ratio

P: specific resistance of the hot line (Ωcm)

L1: interval between bus bars (cm)

N: number of the hot line

A: cross-sectional area of the conductive line (cm²)

P: interval between hot lines (cm)

L2: length of the bus bar (cm)

W: height of the hot line (cm)

H: height of the hot line (cm)

That is, in the case of when the line width w of the hot line is 20 micrometers, the height h is 1.5 micrometers, specific resistance ρ is 3*10-6 Ω·cm, the interval p between the lines is 300 micrometers, L1 is 1 m, and L2 is 1 m, R is 0.3Ω, and the opening ratio is 93.3%, and at this time, if 12 V is applied to both terminals, heat emission of 480 W is ensured.

The heating element according to the exemplary embodiments of the present invention may be applied to glass that is used for various transport means such as vehicles, ships, railroads, high-speed railroads, and airplanes, houses or other buildings. In particular, since the heating element according to the exemplary embodiments of the present invention has an excellent heating property at a low voltage, can minimize side effects by diffraction and interference of single light source after sunset, and can be invisible in the above line width, unlike the known technology, it may be applied to the front window for transport means such as vehicles.

### MODE FOR INVENTION

Hereinafter, the present invention is illustrated through Examples, but the scope of the present invention is not limited by them.

### Example 1

As the silver paste, the silver paste for low temperature sintering that is manufactured by Fujikura, Co., Ltd. was used. As the intaglio, a glass that had patterns that had the interval of 300 micrometers, the width of 20 micrometers, and the depth of 7.5 micrometers and were orthogonally formed in a grid manner was used.

After the polyester-based primer was bar coated on the PET film (thickness of 125 micrometers), it was dried for 2 min to perform the primer treatment. After the grid manner silver pattern was formed by using the manner shown in FIG. 1 and the offset printer, the silver line was formed by sintering it at 150° C. for 30 min. In this case, the interval of the formed silver line was 300 micrometers, the width was 25 micrometers, the height was 1.5 micrometers, and the opening ratio was 84%. After the substrate was cut in the size of 275 mm×270 mm, it was disposed between the EVA that had the thickness of 400 micrometers, and the attachment glass was manufactured by putting the complex between glasses that had the thickness of 3 mm and the size of 270 mm×270 mm and attaching them under 5 atm at 140° C. for 30 min. The bus bar was formed by contacting the portion that was disposed outside the attachment glass in the long axis direction with the copper strip by using the clip. In this case, the resistance between both terminals was 5.4 ohm. In this case, when the voltage of 13 V was applied, the heating amount was 38 W (510 W/m²). As a result of the measurement of the heating phenomenon by using the IR vision camera, the temperature was increased from 20° C. to 50° C. within 5 min. In addition, the temperature deviation percentage value that was obtained by dividing the difference between the maximum value and the minimum value of the temperatures that were measured 20 points within the heating area by the average value was 7% or less for the measurement time.

1. A method for manufacturing a heating element, the method comprising:
determining a form of a pattern in which a line width is 100 micrometers or less and an opening ratio is in the range of 70% to 99%;
printing a paste that includes the conductive heating material according to the determined pattern on at least one side of a resin film;
forming a conductive heating pattern by sintering the printed paste that includes the conductive heating material;
forming bus bars on both sides of the conductive heating pattern;
attaching a transparent substance to at least one side of the resin film that has the conductive heating pattern; and
providing a power portion that is connected to the bus bars.

2. The method for manufacturing a heating element according to claim 1, wherein the printing uses an offset printing method, gravure printing method, flaxo printing method, inkjet printing method, or one or more complex methods of the printing methods.

3. The method for manufacturing a heating element according to claim 1, wherein the conductive heating material includes copper, silver, or carbon nanotube (CNT).

4. The method for manufacturing a heating element according to claim 1, wherein the paste further includes an organic binder and glass frit.

5. The method for manufacturing a heating element according to claim 1, wherein the printing is performed so that an interval between lines of the printing patterns is 30 mm or less after sintering, and a height of the line from the surface of the transparent substrate is in the range of 1 to 100 micrometers.

6. The method for manufacturing a heating element according to claim 1, wherein the pattern is one or more combination patterns of stripe, diamond, lattice, circle, wave pattern, grid, 2-dimensional grid, tide pattern and sine wave of the paste.

7. The method for manufacturing a heating element according to claim 6, wherein the pattern is configured so that spacing or line thickness is irregular.

8. The method for manufacturing a heating element according to claim 1, further comprising layering and attaching additional transparent substance on at least one side of the heating element.

9. The method for manufacturing a heating element according to claim 1, wherein the transparent substance is glass, plastic substrate or plastic film.

10. A heating element comprising:
a) a resin film;
b) a conductive heating pattern that is disposed on at least one side of the resin film, a line width of the pattern being 100 micrometers or less, an opening ratio of the pattern being 70% to 99%;
c) bus bars that are disposed on both ends of the conductive heating pattern;
d) a power portion that is connected to the bus bars; and
e) a transparent substance that is provided on at least one side of the resin film on which the conductive heating pattern is formed.

11. The heating element according to claim 10, wherein the conductive heating pattern is formed by using an offset printing method, gravure printing method, flaxo printing method, inkjet printing method, or one or more complex methods of the printing methods.

12. The heating element according to claim 10, wherein an interval between lines of the conductive heating patterns is 30 mm or less, and a height of the line from the surface of the transparent substrate is in the range of 1 to 100 micrometers.

13. The heating element according to claim 10, wherein a temperature deviation within 5 min after a heating operation is 10% or less.

14. The heating element according to claim 10, wherein 5 or more pattern lines are disposed for 1 cm of the length of the bus bar.

15. The heating element according to claim 10, wherein the heating element includes at least two areas that have different conductive heating patterns.

16. The heating element according to claim 10, wherein the heating element includes an area in which the conductive heating pattern is not formed.

17. The heating element according to claim 10, wherein the conductive heating pattern is blackened.

18. The heating element according to claim 10, wherein the heating element includes an additional transparent substance that is provided on c) the heating pattern.

19. The heating element according to claim 10, wherein the transparent substance is glass, plastic substrate or plastic film.

20. The heating element according to claim 10, wherein the heating element is for a front window of vehicles.
